(19) United States
(12) Patent Application Publication
(10) Pub. No.: US 2025/0251314 A1
(43) Pub. Date: Aug. 7, 2025

(54) METHOD AND HARD TISSUE SLICING MACHINE FOR SLICING HARD TISSUE USING A SLICING BLADE

(71) Applicant: Shanghai Sixth People's Hospital, Shanghai (CN)

(72) Inventors: Changqing Zhang, Shanghai (CN); Junhui Yin, Shanghai (CN)

(21) Appl. No.: 19/186,659

(22) Filed: Apr. 23, 2025

Related U.S. Application Data
(63) Continuation-in-part of application No. 17/170,032, filed on Feb. 8, 2021.

(30) Foreign Application Priority Data
Nov. 30, 2020 (CN) 202011374885.X

(51) Int. Cl. G01N 1/06; G01N 21/95

(52) U.S. Cl. CPC G01N 1/06; G01N 21/95; G01N 2001/061; G01N 2001/065

(57) ABSTRACT

A method for slicing hard tissue using a slicing blade is disclosed. The method includes securing the blade in a blade holder. The slicing blade is integrally manufactured as a single piece with a trapezoidal prism-shaped back portion and a triangular prism-shaped edge portion. The back portion has a vertical height of 27-38 mm, a horizontal length of 8-20 cm, and an end thickness of 4-15 mm. The edge portion has a base angle of 70-85°, a vertical height of 1-3.5 mm, and a horizontal length of 8-20 cm, with the junction between the portions having a thickness of 0.1-0.8 mm. Further, the method includes aligning the blade at an inclination angle over 10°, positioning a resin-embedded tissue sample, calibrating slicing parameters, and producing slices 2 μm-25 μm thick, especially 2 μm-5 μm thick.

### CROSS-REFERENCE TO RELATED APPLICATIONS

This application is a Continuation-In-Part (CIP) of U.S. patent application Ser. No. 17/170,032, titled “NOVEL HARD TISSUE SLICING KNIFE”, filed on Feb. 8, 2021, which further derives priority from Chinese Patent Application 202011374995.X, filed on 30 Nov. 2020, the entirety of which are incorporated herein by reference.

### BACKGROUND

### Technical Field

The present disclosure relates to the field of medical research equipment for tissue slices, and in particular, relates to a method and hard tissue slicing machine for slicing hard tissue using a slicing blade.

### Description of the Related Art

Hard tissues, including those embedded in resin blocks, are often sliced into thin sections for microscopic analysis or other scientific applications. Producing high-quality slices with consistent thickness is critical for ensuring accurate experimental outcomes and reliable diagnostic results. However, slicing hard tissues presents significant challenges due to their rigidity and the risk of deformation during the cutting process. Additionally, improper slicing techniques can lead to damage, such as wrinkling, detachment, or tearing of the tissue, compromising its usability. The process of slicing hard tissues requires tools that provide stability, precision, and uniform force distribution. Conventional slicing blades and machines are often not optimized for this purpose. For instance, standard slicing equipment tends to perform inadequately when faced with hard materials, leading to uneven cuts or excessive sample deformation. These limitations can further impede the ability to achieve ultra-thin slices (e.g., 2 μm to 5 μm) necessary for advanced imaging techniques, such as optical or electron microscopy.

Various tools and techniques exist for tissue slicing, ranging from manually operated microtomes to fully automated slicing machines. Current technologies often rely on standard slicing blades that are unsuitable for hard tissues due to their lack of structural rigidity, improper edge geometry, and limited compatibility with existing knife holders. Conventional blades frequently exhibit suboptimal performance, such as poor durability or inconsistent slice thickness. Machines designed for tissue slicing typically offer limited customization for adjusting critical parameters, such as slicing angles, speeds, and sample alignment, further restricting their applicability for hard tissue samples. Despite incremental improvements in tissue slicing equipment, challenges remain in producing reliable, high-quality slices of hard tissue. Innovations in blade design, machine calibration, and sample preparation have been inadequate in addressing these shortcomings comprehensively. These deficiencies highlight the need for improved systems capable of achieving precision slicing under demanding conditions, such as cutting through resin-embedded samples or slicing hard tissues with varying degrees of hardness.

Thus, there is a need for a comprehensive solution that enables precise, reproducible slicing while minimizing deformation, damage, and inefficiencies. The solution must also accommodate a range of hard tissue types and embedding conditions, providing versatility and reliability for research and clinical applications.

### BRIEF SUMMARY

One or more embodiments are directed to a method and hard tissue slicing machine (hereinafter termed as “disclosed solution”) for slicing hard tissue using a slicing blade. The disclosed solution for slicing hard tissue, such as teeth and bones or ordinary soft tissues, which is embedded in a resin block, addresses the limitations of existing technologies by utilizing a slicing blade characterized by an integrally molded structure with specific geometric attributes. The blade features a back portion with a trapezoidal prism shape and an edge portion with a triangular prism shape, precisely engineered to ensure uniform force distribution and reduce deformation of hard tissue samples during slicing. The junction between the back portion and the edge portion is optimized for stability and durability, with specified dimensions that enhance the blade's performance in demanding slicing applications. The disclosed solution involves securing the slicing blade in a specialized blade holder and aligning the blade at an inclination angle greater than 10 degrees relative to the slicing platform. The tissue sample (either hard tissue such as bones or ordinary soft tissue) is embedded in a resin block or other medium, forming hard tissue (hereinafter termed as “hard tissue”), to provide rigidity and minimize deformation, and it is positioned at a complementary angle to ensure precision during slicing. The disclosed solution incorporates a calibration process that adjusts critical slicing parameters, including slicing speed, thickness, to achieve optimal cutting conditions. The disclosed solution ensures the production of ultra-thin slices, ranging from 2 μm to 25 μm, especially 2 μm to 5 μm, suitable for high-resolution microscopy and other analytical applications.

In an embodiment, the disclosed solution integrates the slicing blade with a specialized hard tissue slicing machine. The machine includes a blade holder, a slicing platform, and modules for input reception, calibration, and operation. The modules allow precise control of slicing parameters and accommodate variations in tissue hardness and embedding conditions. Additionally, the slicing platform includes a clamp mechanism to secure the resin block, minimizing vibrations and ensuring consistent performance. The disclosed solution addresses challenges such as tissue wrinkling, detachment, and irregular slice thickness, which commonly arise with conventional slicing tools and methods. Further, the disclosed solution is particularly effective for slicing resin-embedded samples, where the enhanced rigidity of the block prevents deformation during the slicing process. Furthermore, the disclosed solution supports downstream processing steps, including flattening, drying, and storing slices, ensuring that the samples are preserved in optimal condition for subsequent analysis.

An embodiment of the present disclosure relates to the hard tissue slicing machine for slicing hard tissues using a slicing blade. The slicing blade is manufactured as a single, integrally molded piece and consists of a back portion and an edge portion. The back portion has a trapezoidal prism shape with a vertical height in the range of 27 mm to 38 mm and a horizontal length in the range of 8 cm to 20 cm. The edge portion has a triangular prism shape, with a base angle in the range of 70 degrees to 85 degrees, a vertical height in the range of 1 mm to 3.5 mm, and a horizontal length in the range of 8 cm to 20 cm. The end of the back portion, away from the edge portion, has a thickness in the range of 4 mm to 15 mm. The junction between the back portion and the edge portion forms a rectangular shape along their horizontal lengths, with a shorter side in the range of 0.1 mm to 0.8 mm and a larger side in the range of 8 cm to 20 cm.

In an embodiment, the hard tissue slicing machine includes a blade holder to securely position the slicing blade and a slicing platform that aligns the slicing blade at an inclination angle greater than 10 degrees. The slicing platform receives a hard tissue sample embedded in a resin block, positioned at an angle greater than 10 degrees relative to the slicing blade to minimize deformation during slicing. The hard tissue slicing machine further comprises an input receiving module to specify the type of hard tissue and the desired thickness of the slices. The hard tissue slicing machine incorporates a calibration module to adjust slicing parameters, which include setting a slicing speed to a predefined slow rate to achieve uniform force distribution during slicing, and setting the thickness of slices in the range of 2 μm to 25 μm. An operating module controls the slicing blade based on the calibrated parameters to produce thin slices of hard tissue with minimal deformation.

In an embodiment, the hard tissue slicing machine includes features such as a clamp mechanism on the slicing platform to hold the resin block in a fixed position and minimize vibrations during slicing. The slicing speed can be maintained in the range of 1 mm/s to 3 mm/s to prevent tissue tearing and deformation, and the blade inclination angle relative to the slicing platform can be adjusted between 15 degrees and 25 degrees for optimal cutting performance. The hard tissue slicing machine is compatible with hard tissue samples such as teeth and bones, embedded in resin blocks with a hardness of at least 70 Shore D. Additionally, the resin block can be pre-cooled to a temperature of −20° C. to 4° C. to enhance slicing precision and minimize deformation during the process. After slicing, the hard tissue slicing machine allows for the inspection of sliced tissues using optical microscopy to confirm the absence of wrinkles or detachment. The tissue slices produced can be collected and prepared by flattening them in water to reduce wrinkling, transferring the slices to glass slides, drying them in an oven at 65° C., and storing them at room temperature in a glass slide box for further experimentation. Such features enable the machine to produce precise, high-quality slices that are critical for research and diagnostic applications.

An embodiment of the present disclosure relates to the method for slicing hard tissue using a slicing blade, wherein the method includes the steps of securing the slicing blade in a blade holder. The slicing blade is manufactured as a single, integrally molded piece and comprises a back portion and an edge portion. The back portion has a trapezoidal prism shape with a vertical height in the range of 27 mm to 38 mm and a horizontal length in the range of 8 cm to 20 cm. The edge portion has a triangular prism shape, with a base angle in the range of 70 degrees to 85 degrees, a vertical height in the range of 1 mm to 3.5 mm, and a horizontal length in the range of 8 cm to 20 cm. The end of the back portion, away from the edge portion, has a thickness in the range of 4 mm to 15 mm. The slicing blade also includes a junction between the top portion of the trapezoidal prism-shaped back portion and the base portion of the triangular prism-shaped edge portion, wherein the junction has a rectangular shape with a shorter side in the range of 0.1 mm to 0.8 mm and a longer side in the range of 8 cm to 20 cm.

In an embodiment, the method includes the step of aligning the slicing blade at an inclination angle greater than 10 degrees relative to a slicing platform. Further, the method includes the step of receiving a hard tissue. Further, the hard tissue is positioned at an angle greater than 10 degrees relative to the slicing blade to ensure minimal deformation during slicing. The method includes the step of calibrating slicing parameters, which comprises setting a slicing speed to a predefined slow rate to achieve uniform force distribution during slicing, and adjusting the thickness of slices to a range of 2 μm to 25 μm. The method includes the step of operating the slicing blade based on the calibrated slicing parameters to produce slices of the hard tissue with thicknesses ranging from 2 μm to 25 μm, especially 2 μm to 5 μm, while minimizing deformation.

In an embodiment, the method includes forming the slicing blade as a single, integrally molded structure. Connection between the back portion and the edge portion includes a gradual taper to ensure uniform force distribution. The method includes the step of configuring the slicing platform to hold the resin block in a fixed position using a clamp mechanism to minimize vibrations during slicing. Further, the method includes maintaining the slicing speed in the range of 0.1 mm/s to 5 mm/s to prevent tissue tearing and deformation, as well as setting the inclination angle of the slicing blade relative to the slicing platform between 15 degrees and 25 degrees for optimal cutting performance. The method includes the step of slicing hard tissue (including hard tissues such as teeth and bones or ordinary soft tissue embedded in resin blocks and other mediums) with a hardness of at least 70 Shore D. The method includes pre-cooling the resin block to a temperature of −20° C. to 4° C. to enhance slicing precision and minimize deformation.

Additionally, the method includes the steps of collecting and preparing the tissue slices by flattening the slices in water to reduce wrinkling, transferring the slices to glass slides, drying them in an oven at 65° C., and storing them at room temperature in a glass slide box for further experimentation. The method includes inspecting the sliced tissues using optical microscopy to confirm the absence of wrinkles or detachment, ensuring the production of high-quality slices for subsequent research or diagnostic applications.

The features and advantages of the subject matter here will become more apparent in light of the following detailed description of selected embodiments, as illustrated in the accompanying FIGUREs. As will be realized, the subject matter disclosed is capable of modifications in various respects, all without departing from the scope of the subject matter. Accordingly, the drawings and the description are to be regarded as illustrative in nature.

### BRIEF DESCRIPTION OF THE DRAWINGS

In the figures, similar components and/or features may have the same reference label. Further, various components of the same type may be distinguished by following the reference label with a second label that distinguishes among the similar components. If only the first reference label is used in the specification, the description is applicable to any one of the similar components having the same first reference label irrespective of the second reference label.

FIG. 1A illustrates a perspective view of a slicing blade, in accordance with an embodiment of the present disclosure.

FIG. 1B illustrates a top view of the slicing blade, in accordance with an embodiment of the present disclosure.

FIG. 1C illustrates a cross-sectional view of the slicing blade, in accordance with an embodiment of the present disclosure.

FIG. 2A illustrates a perspective view of a hard tissue slicing machine, in accordance with an embodiment of the present disclosure.

FIG. 2B illustrates a back view of the hard tissue slicing machine, in accordance with an embodiment of the present disclosure.

FIG. 3 illustrates a front view of the control panel, in accordance with an embodiment of the present disclosure.

FIGS. 4A-4F illustrates various views of a blade holder, in accordance with an embodiment of the present disclosure.

FIG. 5A illustrates a groove for receiving the blade holder, in accordance with an embodiment of the present disclosure.

FIG. 5B illustrates the blade holder with the slicing blade with locked fixed knob, in accordance with an embodiment of the present disclosure.

FIG. 6 illustrates a tool washer, in accordance with an embodiment of the present disclosure.

FIG. 7A illustrates a slot of the blade holder, in accordance with an embodiment of the present disclosure.

FIG. 7B illustrates the blade holder with aligned knob, in accordance with an embodiment of the present disclosure.

FIG. 7C illustrates the blade holder with the tool washer installed, in accordance with an embodiment of the present disclosure.

FIG. 8 is a flow chart of a method for slicing hard tissue using a slicing blade, in accordance with an embodiment of the present disclosure.

Other features of embodiments of the present disclosure will be apparent from accompanying drawings and detailed description that follows.

### DETAILED DESCRIPTION

Embodiments of the present disclosure include various steps, which will be described below. The steps may be performed by hardware components or may be embodied in machine-executable instructions, which may be used to cause a general-purpose or special-purpose processor programmed with the instructions to perform the steps. Alternatively, steps may be performed by a combination of hardware, software, firmware, and/or by human operators.

Various methods described herein may be practiced by combining one or more machine-readable storage media containing the code according to the present disclosure with appropriate standard computer hardware to execute the code contained therein. An apparatus for practicing various embodiments of the present disclosure may involve one or more computers (or one or more processors within the single computer) and storage systems containing or having network access to a computer program(s) coded in accordance with various methods described herein, and the method steps of the disclosure could be accomplished by modules, routines, subroutines, or subparts of a computer program product, or combining slicing machines available in the market.

### Terminology

Brief definitions of terms used throughout this application are given below.

The terms “connected” or “coupled”, and related terms are used in an operational sense and are not necessarily limited to a direct connection or coupling. Thus, for example, two devices may be coupled directly, or via one or more intermediary media or devices. As another example, devices may be coupled in such a way that information can be passed there between, while not sharing any physical connection with one another. Based on the disclosure provided herein, one of ordinary skill in the art will appreciate a variety of ways in which connection or coupling exists in accordance with the aforementioned definition.

If the specification states a component or feature “may”, “can”, “could”, or “might” be included or have a characteristic, that particular component or feature is not required to be included or have the characteristic.

As used in the description herein and throughout the claims that follow, the meaning of “a,” “an,” and “the” includes plural reference unless the context dictates otherwise. Also, as used in the description herein, the meaning of “in” includes “in” and “on” unless the context dictates otherwise.

The phrases “in an embodiment,” “according to one embodiment,” and the like generally mean the particular feature, structure, or characteristic following the phrase is included in at least one embodiment of the present disclosure and may be included in more than one embodiment of the present disclosure. Importantly, such phrases do not necessarily refer to the same embodiment.

The phrase “hard tissue” means Soft and hard tissues (including hard tissues such as bone and ordinary soft tissues) embedded in resin block or other mediums.

Exemplary embodiments will now be described more fully hereinafter with reference to the accompanying drawings, in which exemplary embodiments are shown. This disclosure may, however, be embodied in many different forms and should not be construed as limited to the embodiments set forth herein. These embodiments are provided so that this disclosure will be thorough and complete and will fully convey the scope of the disclosure to those of ordinary skill in the art. Moreover, all statements herein reciting embodiments of the disclosure, as well as specific examples thereof, are intended to encompass both structural and functional equivalents thereof. Additionally, it is intended that such equivalents include both currently known equivalents as well as equivalents developed in the future (i.e., any elements developed that perform the same function, regardless of structure).

Thus, for example, it will be appreciated by those of ordinary skill in the art that the diagrams, schematics, illustrations, and the like represent conceptual views or processes illustrating systems and methods embodying this disclosure. The functions of the various elements shown in the figures may be provided through the use of dedicated hardware as well as hardware capable of executing associated software. Similarly, any switches shown in the figures are conceptual only. Their function may be carried out through the operation of program logic, through dedicated logic, through the interaction of program control and dedicated logic, or even manually, the particular technique being selectable by the entity implementing this disclosure. Those of ordinary skill in the art further understand that the exemplary hardware, software, processes, methods, and/or operating systems described herein are for illustrative purposes and, thus, are not intended to be limited to any particular named.

One or more embodiments are directed to a method and hard tissue slicing machine (hereinafter termed as “disclosed solution”) for slicing hard tissue using a slicing blade. The disclosed solution for slicing hard tissues addresses the limitations of existing technologies by utilizing a slicing blade characterized by an integrally molded structure with specific geometric attributes. The blade features a back portion with a trapezoidal prism shape and an edge portion with a triangular prism shape, precisely engineered to ensure uniform force distribution and reduce deformation of hard tissue samples during slicing. The junction between the back portion and the edge portion is optimized for stability and durability, with specified dimensions that enhance the blade's performance in demanding slicing applications. The disclosed solution involves securing the slicing blade in a specialized blade holder and aligning the blade at an inclination angle greater than 10 degrees relative to the slicing platform. The tissue sample is embedded in a resin block to provide rigidity and minimize deformation, and it is positioned at a complementary angle to ensure precision during slicing. The disclosed solution incorporates a calibration process that adjusts critical slicing parameters, including slicing speed, thickness, to achieve optimal cutting conditions. The disclosed solution ensures the production of ultra-thin slices, ranging from 2 μm to 25 μm, suitable for high-resolution microscopy and other analytical applications.

In an embodiment, the disclosed solution integrates the slicing blade with a specialized hard tissue slicing machine. The machine includes a blade holder, a slicing platform, and modules for input reception, calibration, and operation. These modules allow precise control of slicing parameters and accommodate variations in tissue hardness and embedding conditions. Additionally, the slicing platform features a clamp mechanism to secure the resin block, minimizing vibrations and ensuring consistent performance. The disclosed solution addresses challenges such as tissue wrinkling, detachment, and irregular slice thickness, which commonly arise with conventional slicing tools and methods. It is particularly effective for slicing resin-embedded samples, where the enhanced rigidity of the block prevents deformation during the slicing process. Furthermore, the invention supports downstream processing steps, including flattening, drying, and storing slices, ensuring that the samples are preserved in optimal condition for subsequent analysis.

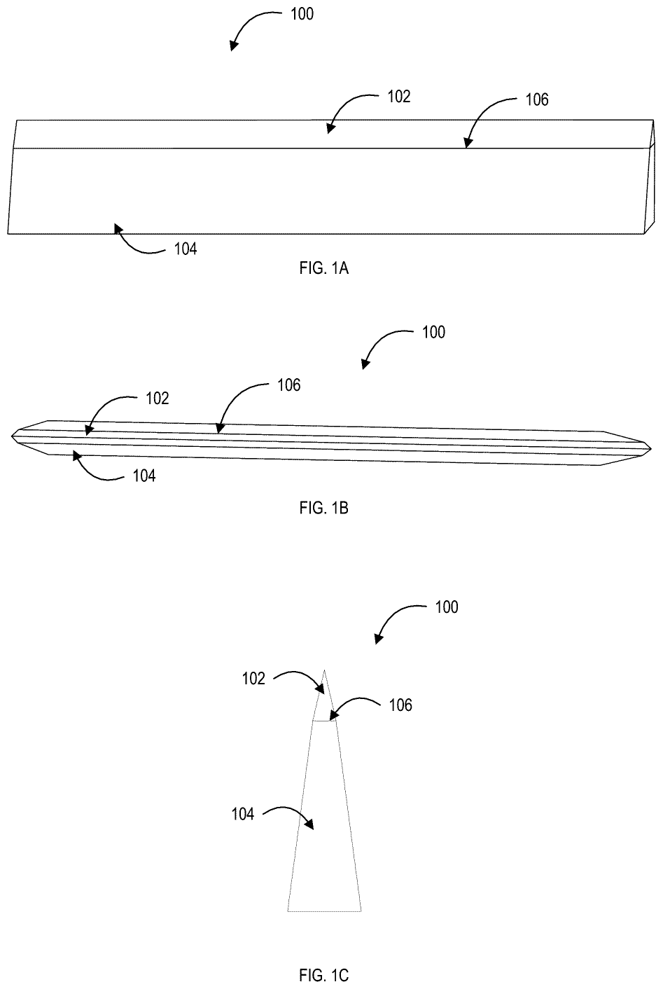

FIG. 1A illustrates a perspective view of a slicing blade 100, in accordance with an embodiment of the present disclosure. FIG. 1B illustrates a top view of the slicing blade 100, in accordance with an embodiment of the present disclosure. FIG. 1C illustrates a cross-sectional view of the slicing blade 100, in accordance with an embodiment of the present disclosure.

In an embodiment, the slicing blade 100 may be integrally molded as a single, continuous structure, ensuring durability, reliability, and uniform force transfer during slicing operations. As illustrated, the slicing blade 100 may include an edge portion 102 and a back portion 104. It may be apparent to a person skilled in the art that the edge portion 102 may perform the cutting operation and the back portion 104 may provide support for securing the slicing blade 100 a slicing machine.

In an embodiment, the edge portion 102 of the slicing blade 100 has a cross-sectional shape of an isosceles triangle and thus, may also be referred to as a triangular edge portion 102 for explaining some embodiment/parts of the present disclosure. The triangular edge portion 102 is sharp and facilitates slicing through slicing material such as hard tissues. Further, the edge portion 102 may have a vertical height in the range of 1 mm to 3.5 mm, with a horizontal length in a range of 8 cm to 20 cm. Further, the base angles of the triangular edge portion 102 may be in the range of 70 degrees to 85 degrees, forming an optimal geometry for cutting efficiency. Furthermore, the faces of the triangular edge portion 102 meet at an angle in the range of approximately 10 degrees to 40 degrees, providing a sharp and precise cutting edge.

In an embodiment, the back portion 104 may have a cross-sectional shape of an isosceles trapezoid, providing structural stability to the slicing blade 100 and thus, may also be referred to as a trapezoidal back portion 104 for explaining some embodiments/parts of the present disclosure. Further, the trapezoidal back portion 104 may have a vertical height in the range of 27 mm to 38 mm and a horizontal length matching that of the edge portion 102 i.e., in the range of 8 cm to 20 cm. Such configuration may ensure compatibility with standard blade holders and slicing machines. The broader base of the trapezoidal back portion 104 may provide a robust foundation, while the narrower top transitions into the edge portion 102 for enhanced precision. The thickness of the back portion 104 at its end, opposite the edge portion 102 ranges from 4 mm to 15 mm, enabling the slicing blade 100 to withstand significant forces during hard tissue slicing.

In an embodiment, a junction 106 may be formed, between the edge portion 102 and the back portion 104, along the horizontal lengths of the back portion 104 and edge portion 102, and has a rectangular cross-section with a thickness in the range of 0.1 mm to 0.8 mm. Such junction 106 ensures uniform transfer of forces from the back portion 104 to the edge portion 102, contributing to the blade's stability and slicing performance for cutting hard tissues. Additionally, such a unique and precise design minimizes vibrations and enhances the precision of the slices of the hard tissue.

FIG. 1B emphasizes sharpness of the edge portion 102 and the uniformity of its geometry through a clear representation of its elongated structure. The horizontal length of the slicing blade 100, ranges from 8 cm to 20 cm. Such range ensures that the slicing blade 100 is suitable for a variety of slicing machines and tissue sizes. Further, such a design ensures consistent slicing thickness, which is critical for achieving slices in the range of 2 μm to 25 μm, especially 2 μm to 5 μm, required for high-resolution microscopic analysis. FIG. 1C highlights the geometric relationship between the back portion 104 and the edge portion 102. The back portion's trapezoidal cross-section provides a wide base for stability and gradually tapers to form the junction 106 with the triangular edge portion 102. Further, the inclined faces of the triangular edge portion 102 meet at an angle between 10 degrees and 40 degrees, allowing the slicing blade 100 to penetrate hard tissue samples with minimal resistance. Further, the rectangular junction 106 ensures that the transition between the back portion 104 and the edge portion 102 is seamless, preventing stress concentrations that could compromise the slicing blade's structural integrity during operation.

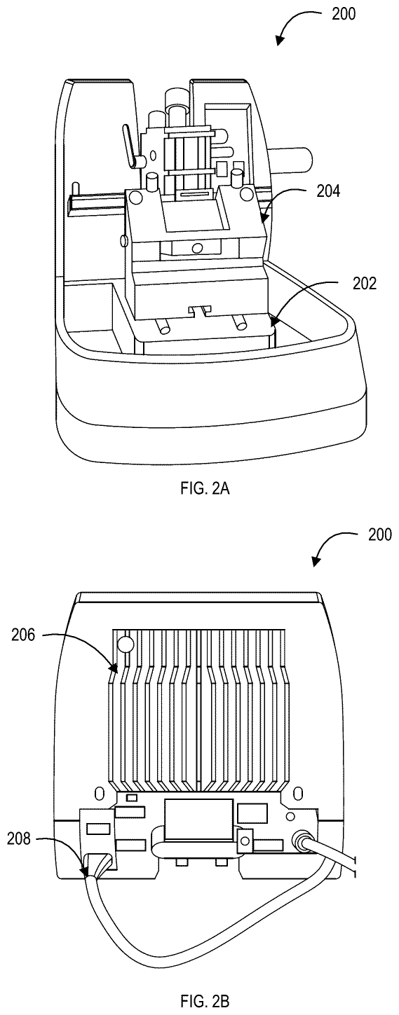

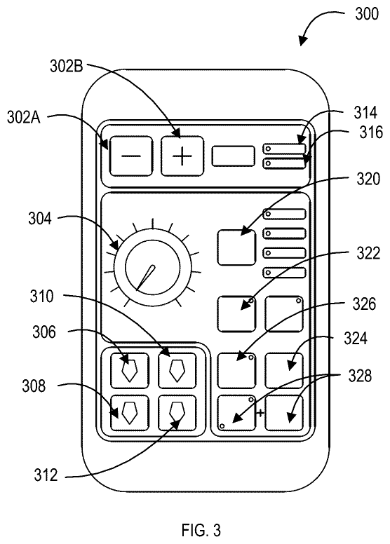

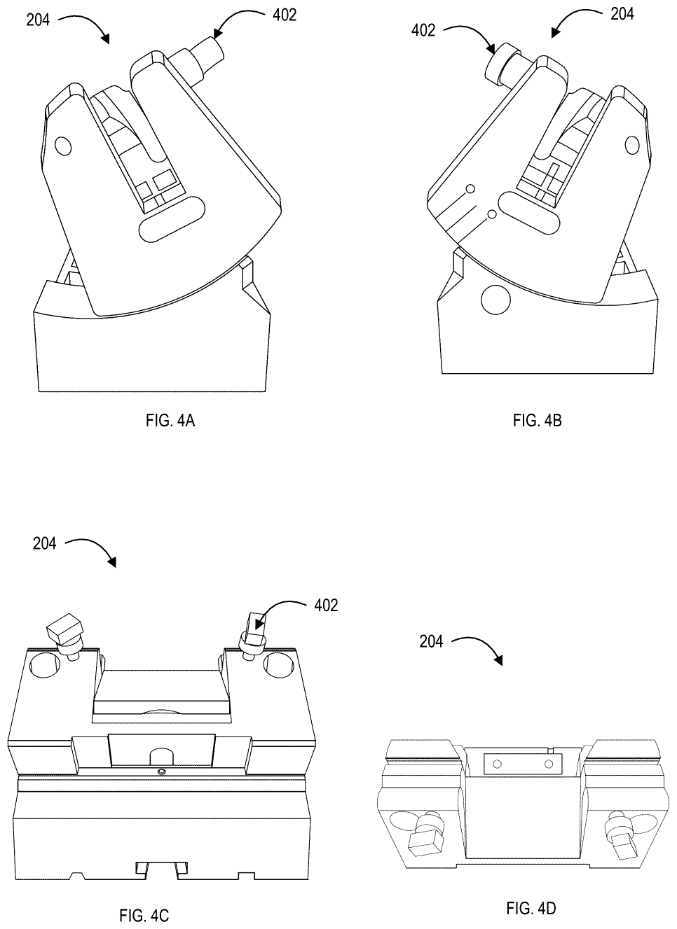

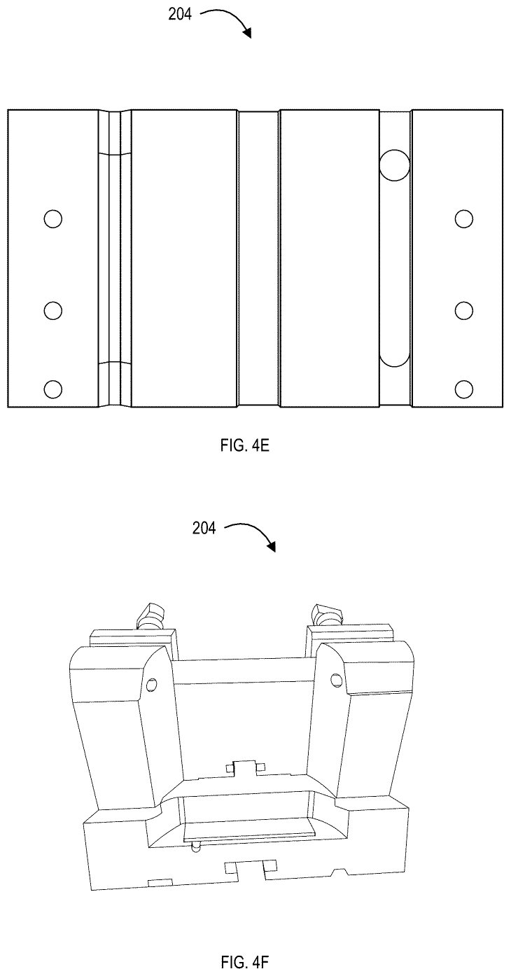

FIG. 2A illustrates a perspective view of a hard tissue slicing machine 200, in accordance with an embodiment of the present disclosure. FIG. 2B illustrates a back view of the hard tissue slicing machine 200, in accordance with an embodiment of the present disclosure. FIG. 3 illustrates a front view of a control panel 300, in accordance with an embodiment of the present disclosure. FIGS. 4A-4F illustrates various views of a blade holder 204, in accordance with an embodiment of the present disclosure. For the sake of brevity, FIGS. 2A, 2B, 3, and 4A-4F have been explained together.

In an embodiment, the hard tissue slicing machine 200 may facilitate high-quality slicing with minimal deformation, providing reliable results for applications such as microscopy, diagnostics, and research. As shown in FIG. 2A, the hard tissue slicing machine 200 may include a slicing platform 202 which may serve as the base for holding and supporting the tissue sample during slicing. Further, the hard tissue slicing machine 200 may include a blade holder 204 to securely mount the slicing blade 100 and position the secured blade above the slicing platform 202. The blade holder 204 may facilitate precise alignment of the slicing blade 100 relative to the slicing platform 202, enabling uniform force distribution and accurate slicing of the resin-embedded hard tissue. Further, the hard tissue slicing machine 200 may be encased within a housing that provides structural support and protection to the internal components as well as contributes to the ergonomic design of the hard tissue slicing machine 200, ensuring ease of use for the operator.

In an embodiment, the slicing platform 202 may include a securing structure including, but not limited to, grooves, slots, or a clamp mechanism to hold the resin block securely in place, minimizing vibrations and enhancing the accuracy of the slices. Further, the slicing platform 202 may provide a flat and stable surface to hold the resin block containing the hard tissue sample through a top surface that may be made from materials with high wear resistance to withstand repeated slicing operations.

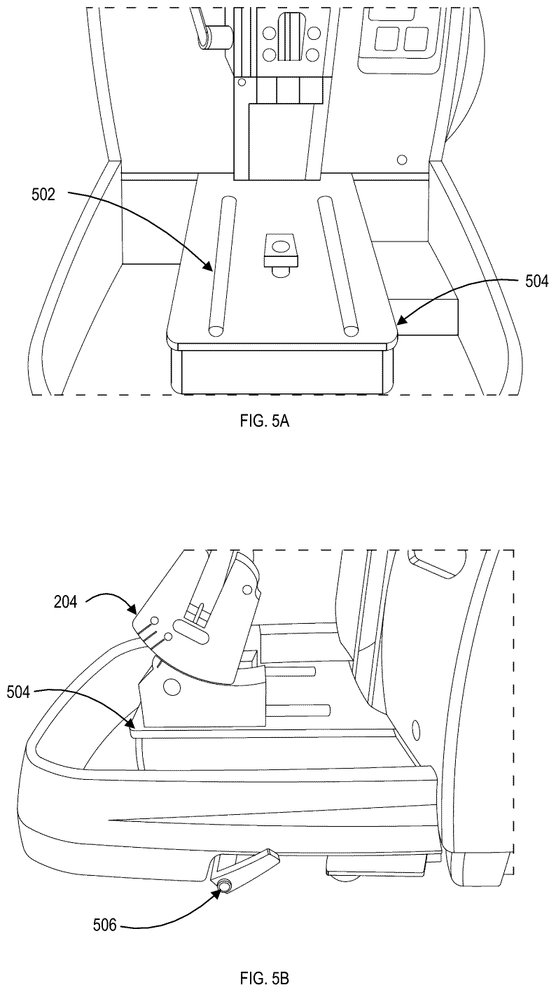

In an embodiment, as shown in FIGS. 4A-4F, the blade holder 204 may be designed to securely mount the slicing blade 100, ensuring stability during operation. The blade holder 204 may include a locking mechanism 402 that may prevent the slicing blade 100 from shifting or vibrating during slicing, which is critical for producing uniform slices of 2 μm to 25 μm in thickness. Further, the slicing platform 202 and/or the blade holder 204 may be coupled with an inclination adjustment mechanism that may allow the slicing blade 100 to be set at an angle greater ranging between 15 degrees and 25 degrees relative to the slicing platform 202 to ensures optimal cutting performance for different tissue types and embedding materials. Specifically, such an angle may be set at least 15 degrees for the hard tissue resin block. Attachment of the slicing blade 100 on the blade holder 204 has been explained in detail in the following paragraphs corresponding to at least FIGS. 5A and 5B.

In an embodiment, the hard tissue slicing machine 200 may include an input receiving module to receive nature of the hard tissue and required thickness. Further, the hard tissue slicing machine 200 may include a calibration module to adjust slicing parameters such as speed, slice thickness. The calibration module may enable precise tuning of these parameters, ensuring consistent results. For example, slicing speed can be adjusted between 0.1 mm/s and 5 mm/s, while slice thickness can range from 2 μm to 25 μm, to achieve uniform force distribution during slicing. Such calibration may be performed using an exemplary control panel 300, as shown in FIG. 3. Such control panel 300 may be external or internal to the hard tissue slicing machine 200, without departing from the scope of the disclosure. In an illustrated embodiment, the control panel 300 may include, without any limitation, set section thickness/trimming thickness buttons 302A and 302B, a set sectioning speed knob 304, reverse coarse feed knob (fast) button 306, forward coarse feed knob (slow) button 308, reverse coarse feed knob (slow) button 310, forward coarse feed knob (fast) button 312 trim light 314, section light 316, cut mode button 320, memory button 322 trim/section selector button 324, brake button 326, and run/stop motorized sectioning button 328.

In an embodiment, the hard tissue slicing machine 200 may include a cooling mechanism that may be integrated into the slicing platform 202 or the housing to maintain the resin block at an optimal temperature (e.g., approximately −20° C. to 4° C.) which may reduce tissue deformation during slicing and enhances the precision of the slices. Further, as shown in FIG. 2B, the back view of the slicing machine 200 may include an exhaust system 206 to prevent overheating of internal components and a power supply unit 208 for providing electricity to the motor and other electrical components of the hard tissue slicing machine 200. In an embodiment, the hard tissue slicing machine 200 may also include a slice collection tray, positioned adjacent to the slicing platform 202 may be included to safely collect and store the sliced samples and ensure that the slices are not damaged or contaminated after slicing. Such collected samples may be prepared and stored by flattening the tissue slices in water to reduce wrinkling, transferring the slices to glass slides, drying the slices in an oven at 65° C., and storing the dried slices at room temperature in a glass slide box for further experimentation.

In an embodiment, the hard tissue slicing machine 200 may be versatile and can be adapted for a wide range of applications. For instance, the slicing platform 202 may support resin blocks with varying hardness levels, including those exceeding 70 Shore D. The machine's compatibility with various blade geometries and materials allows it to handle diverse slicing requirements, such as ultra-thin slicing for high-resolution imaging. In an embodiment, the hard tissue slicing machine 200 may not be limited to a specific design or application and may be configured as a manual, semi-automatic, or fully automatic machine, depending on user requirements. Specifically, the hard tissue slicing machine 200 may be optimized for producing ultra-thin slices of hard tissue. The slicing blade's unique geometry, coupled with the machine's advanced calibration and alignment features, ensures consistent slice thickness and minimal deformation. Such characteristics make the hard tissue slicing machine 200 particularly suitable for high-resolution microscopy and other analytical techniques.

FIG. 5A illustrates a groove 502 for receiving the blade holder 204, in accordance with an embodiment of the present disclosure. FIG. 5B illustrates the blade holder 204 with the slicing blade 100 with locked fixed knob, in accordance with an embodiment of the present disclosure. For the sake of brevity, FIGS. 5A and 5B have been explained together.

As shown in FIG. 5A, the blade holder 204 may be configured with the groove 502 designed to securely receive the slicing blade 100. The groove 502 may be machined with precise dimensions to ensure a snug and stable fit for the blade holder 204 and may extend along the length of the blade holder 204 oriented at an angle that aligns with the slicing platform 202. Such alignment ensures that the slicing blade 100 remains firmly in place during operation, minimizing vibrations and enhancing cutting precision. The blade holder 204 is mounted on a support base 504, which provides structural integrity and allows for easy installation and removal of the slicing blade 100. Further, as shown in FIG. 5B, a locking knob 506 may be used to secure the slicing blade 100 within the groove 502. The locking knob 506 may be adjustable and can be tightened to ensure that the slicing blade 100 remains fixed during slicing operations. The locking mechanism may be designed to accommodate slicing blades of various dimensions, allowing the machine 200 to be used with different types of blades as needed. The blade holder 204 may be pivotally mounted to the slicing platform 202, allowing for adjustments in the inclination angle of the blade relative to the slicing platform 202.

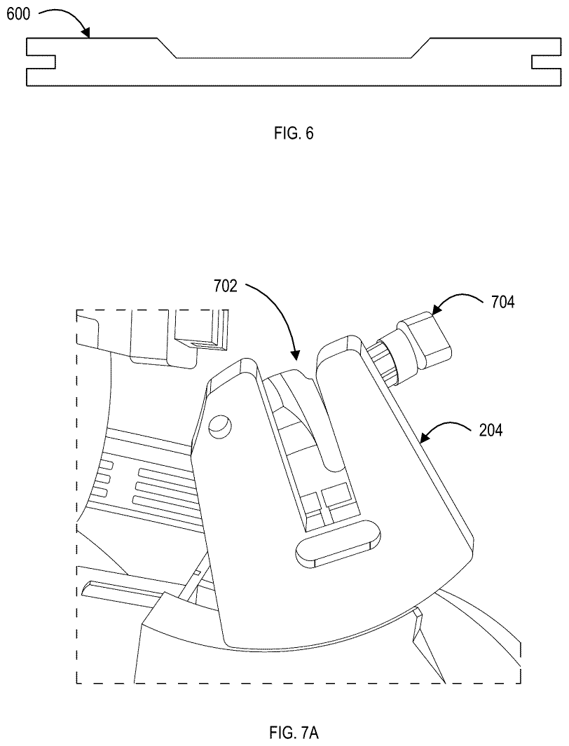

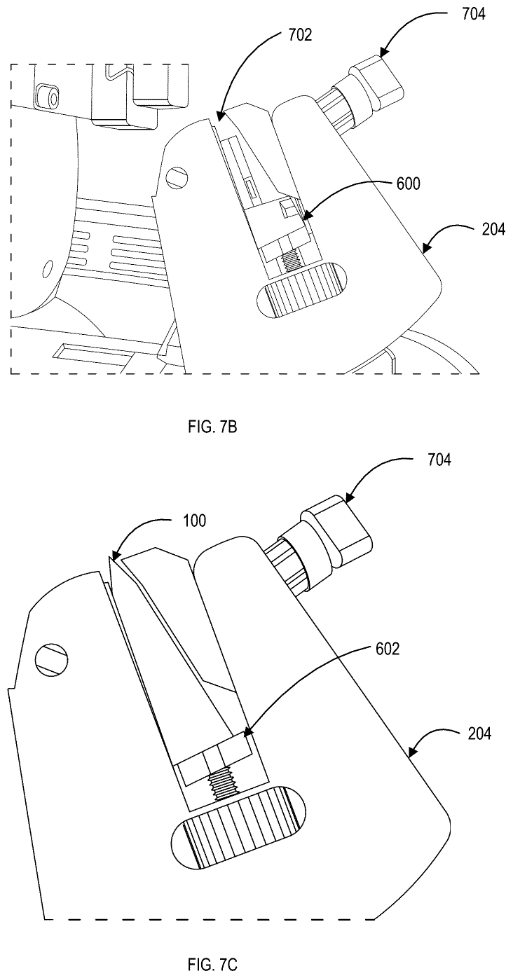

FIG. 6 illustrates a tool washer 600, in accordance with an embodiment of the present disclosure. FIG. 7A illustrates a slot 702 of the blade holder 204, in accordance with an embodiment of the present disclosure. FIG. 7B illustrates the blade holder 204 with aligned knob 704, in accordance with an embodiment of the present disclosure. FIG. 7C illustrates the blade holder 204 with the tool washer 600 installed, in accordance with an embodiment of the present disclosure. For the sake of brevity, FIGS. 6, 7A, 7B, and 7C have been explained together.

In an embodiment, as shown in FIG. 6, the tool washer 600 may be configured to assist in aligning and securing the slicing blade within the blade holder. Further, the tool washer 600 may receive a fastening element, such as a knob or screw, and may also include multiple peripheral notches or ridges that interact with corresponding elements on the blade holder 204 to ensure precise alignment during installation. Further, the blade holder 204, as shown in FIG. 7A, may have a slot 702 designed to accommodate the slicing blade 100 and the tool washer 600. The slot 702 may be configured to align the slicing blade 100 at a specific angle relative to the slicing platform 202, ensuring optimal cutting performance. Further, the slot 702 may include a groove to hold the slicing blade 100 securely in place and prevent lateral movement during slicing. Further, as illustrated in FIG. 7B, the blade holder 204 may be coupled to a knob 704 for alignment that interacts with the tool washer 600. The knob 704 may be positioned to apply uniform pressure on the slicing blade 100, securing it within the slot 702. Such knob 704 may be threaded and may include a handle or grip to facilitate manual tightening. In an embodiment, when the blade holder 204 is installed with the tool washer 600, as illustrated in FIG. 7C, the tool washer 600 may sit within the slot 702 and provide an additional layer of stability by distributing the force applied by the aligned knob 704 evenly across the slicing blade 100.

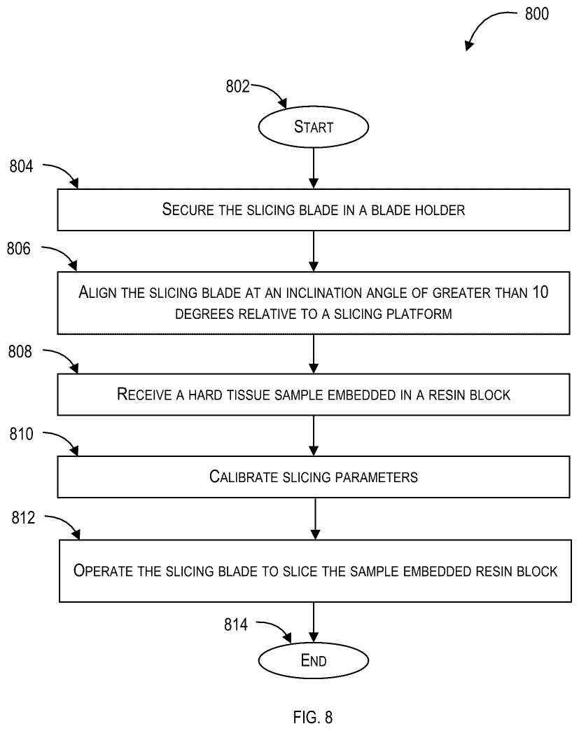

FIG. 8 is a flow chart 800 of a method for slicing hard tissue using a slicing blade, in accordance with an embodiment of the present disclosure. The method starts at step 802.

At first, at step 804, the method includes securing the slicing blade in a blade holder. The slicing blade is manufactured as a single, integrally molded piece and comprises a back portion and an edge portion. The back portion has a trapezoidal prism shape with a vertical height in the range of 27 mm to 38 mm and a horizontal length in the range of 8 cm to 20 cm. The edge portion has a triangular prism shape, with a base angle in the range of 70 degrees to 85 degrees, a vertical height in the range of 1 mm to 3.5 mm, and a horizontal length in the range of 8 cm to 20 cm. The end of the back portion, away from the edge portion, has a thickness in the range of 4 mm to 15 mm. The slicing blade also includes a junction between the top portion of the trapezoidal prism-shaped back portion and the base portion of the triangular prism-shaped edge portion, wherein the junction has a rectangular shape with a shorter side in the range of 0.1 mm to 0.8 mm and a longer side in the range of 8 cm to 20 cm.

Next, at step 806, the method includes the step of aligning the slicing blade at an inclination angle greater than 10 degrees relative to a slicing platform. Next, at step 808, the method includes the step of receiving a hard tissue, is positioned at an angle greater than 10 degrees relative to the slicing blade to ensure minimal deformation during slicing.

Next, at step 810, the method includes the step of calibrating slicing parameters, which comprises setting a slicing speed to a predefined slow rate, to achieve uniform force distribution during slicing, and adjusting the thickness of slices to a range of 2 μm to 25 μm.

Thereafter, at step 812 the method includes the step of operating the slicing blade based on the calibrated slicing parameters to produce slices of the hard tissue with thicknesses ranging from 2 μm to 25 μm while minimizing deformation. The method ends at step 812.

In an embodiment, the method includes additional steps to enhance slicing precision and sample preparation. These include forming the slicing blade as a single, integrally molded structure, wherein the connection between the back portion and the edge portion includes a gradual taper to ensure uniform force distribution. The method includes the step of configuring the slicing platform to hold the resin block in a fixed position using a clamp mechanism to minimize vibrations during slicing. It also includes maintaining the slicing speed in the range of 0.11 mm/s to 5 mm/s to prevent tissue tearing and deformation, as well as setting the inclination angle of the slicing blade relative to the slicing platform between 15 degrees and 25 degrees for optimal cutting performance. The method includes the step of slicing hard tissue with a hardness of at least 70 Shore D. The method further includes pre-cooling the resin block to a temperature of −20 to 4° C. to enhance slicing precision and minimize deformation.

Additionally, the method includes the steps of collecting and preparing the tissue slices by flattening the slices in water to reduce wrinkling, transferring the slices to glass slides, drying them in an oven at 65° C., and storing them at room temperature in a glass slide box for further experimentation. The method also includes inspecting the sliced tissues using optical microscopy to confirm the absence of wrinkles or detachment, ensuring the production of high-quality slices for subsequent research or diagnostic applications.

While embodiments of the present disclosure have been illustrated and described, it will be clear that the disclosure is not limited to these embodiments only. Numerous modifications, changes, variations, substitutions, and equivalents will be apparent to those skilled in the art, without departing from the spirit and scope of the disclosure, as described in the claims.

Thus, it will be appreciated by those of ordinary skill in the art that the diagrams, schematics, illustrations, and the like represent conceptual views or processes illustrating systems and methods embodying this disclosure. The functions of the various elements shown in the figures may be provided through the use of dedicated hardware as well as hardware capable of executing associated software. Similarly, any switches shown in the figures are conceptual only. Their function may be carried out through the operation of program logic, through dedicated logic, through the interaction of program control and dedicated logic, or even manually, the particular technique being selectable by the entity implementing this disclosure. Those of ordinary skill in the art further understand that the exemplary hardware, software, processes, methods, and/or operating systems described herein are for illustrative purposes and, thus, are not intended to be limited to any particular named.

As used herein, and unless the context dictates otherwise, the term “coupled to” is intended to include both direct coupling (in which two elements that are coupled to each other contact each other) and indirect coupling (in which at least one additional element is located between the two elements). Therefore, the terms “coupled to” and “coupled with” are used synonymously. Within the context of this document terms “coupled to” and “coupled with” are also used euphemistically to mean “communicatively coupled with” over a network, where two or more devices can exchange data with each other over the network, possibly via one or more intermediary device.

It should be apparent to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refer to at least one of something selected from the group consisting of A, B, C . . . and N, the text should be interpreted as requiring only one element from the group, not A plus N, or B plus N, etc.

While the foregoing describes various embodiments of the invention, other and further embodiments of the invention may be devised without departing from the basic scope thereof. The scope of the invention is determined by the claims that follow. The invention is not limited to the described embodiments, versions, or examples, which are included to enable a person having ordinary skill in the art to make and use the invention when combined with information and knowledge available to the person having ordinary skill in the art.

What is claimed is:

1. A method for slicing hard tissue using a slicing blade, the method comprising:
securing the slicing blade in a blade holder, wherein the slicing blade having:
a back portion and an edge portion which are manufactured as a single piece,
wherein the back portion has a cross section of an isosceles trapezoid, a vertical height in a range of 27 mm to 38 mm, and a horizontal length in a range of 8 cm to 20 cm, such that the back portion is trapezoidal prism shaped,
wherein the edge portion has a cross section of an isosceles triangle with a base angle in a range of 70 degrees to 85 degrees, a vertical height in a range of 1 mm to 3.5 mm, and a horizontal length in a range of 8 to 20 cm, such that the back portion is triangular prism shaped with two faces of the edge portion at an angle in a range of 10 degrees to 40 degrees,
wherein an end of the back portion which is away from the edge portion, has a thickness in a range of 4 mm to 15 mm; and
a junction between a top portion of the trapezoidal prism shape back portion and a base portion of the triangular prism shaped edge portion formed along the horizontal lengths of the back portion and the horizontal length of the edge portion has a thickness in a range of 0.1 mm to 0.8 mm, such that the junction is rectangular shaped with shorter side in a range of 0.1 mm to 0.8 mm and larger side in a range of 8 cm to 20 cm;
aligning the slicing blade at an inclination angle of greater than 10 degrees relative to a slicing platform;
receiving a hard tissue onto the slicing platform, positioned at an angle greater than 10 degrees relative to the slicing blade;
calibrating slicing parameters, including at least setting a thickness of slices ranging from 2 μm to 25 μm; and
operating the slicing blade based on the calibrated slicing parameters to slice the hard tissue to produce sample slices of 2 μm to 25 μm.

2. The method of claim 1, wherein the slicing blade is formed as a single, integrally molded structure, and the connection between the back portion and the edge portion includes a gradual taper.

3. The method of claim 1, wherein the slicing platform is configured to hold the hard tissue in a fixed position using a clamp mechanism.

4. The method of claim 1, wherein the slicing speed is maintained between 0.1 mm/s and 5 mm/s.

5. The method of claim 1, wherein the inclination angle of the slicing blade relative to the hard tissue is set between 15 degrees and 25 degrees.

6. The method of claim 1, wherein the hard tissue includes hard tissues and ordinary soft tissues embedded in the resin block as a medium having a hardness of at least 70 Shore D.

7. The method of claim 1, wherein the thickness of slices is set ranging from 2 μm to 5 μm.

8. The method of claim 1, wherein the resin block embedding the hard tissue is pre-cooled to a temperature of −20° C. to 4° C.

9. The method of claim 1, further comprising inspecting the sliced tissue using optical microscopy to confirm the absence of wrinkles or detachment.

10. A hard tissue slicing machine for slicing hard tissue using a slicing blade, the hard tissue slicing machine comprising:
the slicing blade having:
a back portion and an edge portion which are manufactured as a single piece,
wherein the back portion has a cross section of an isosceles trapezoid, a vertical height in a range of 27 mm to 38 mm, and a horizontal length in a range of 8 cm to 20 cm, such that the back portion is trapezoidal prism shaped,
wherein the edge portion has a cross section of an isosceles triangle with a base angle in a range of 70 degrees to 85 degrees, a vertical height in a range of 1 mm to 3.5 mm, and a horizontal length in a range of 8 to 20 cm, such that the back portion is triangular prism shaped with two faces of the edge portion at an angle in a range of 10 degrees to 40 degrees,
wherein an end of the back portion which is away from the edge portion, has a thickness in a range of 4 mm to 15 mm; and
a junction between a top portion of the trapezoidal prism shape back portion and a base portion of the triangular prism shaped edge portion formed along the horizontal lengths of the back portion and the horizontal length of the edge portion has a thickness in a range of 0.1 mm to 0.8 mm, such that the junction is rectangular shaped with shorter side in a range of 0.1 mm to 0.8 mm and larger side in a range of 8 cm to 20 cm;
a blade holder to secure the slicing blade;
a slicing platform to align the slicing blade at an inclination angle of greater than 10 degrees, wherein the slicing platform receives a hard tissue onto the slicing platform, further wherein the hard tissue is positioned at an angle greater than 10 degrees relative to the slicing blade;
a calibration module to calibrate slicing parameters, including at least setting a thickness of slices ranging from 2 μm to 25 μm; and
an operating module to operate the slicing blade based on the calibrated slicing parameters to slice the hard tissue to produce sample slices of 2 μm to 25 μm.

11. The hard tissue slicing machine of claim 10, wherein the slicing blade is formed as a single, integrally molded structure, and the connection between the back portion and the edge portion includes a gradual taper.

12. The hard tissue slicing machine of claim 10, wherein the slicing platform is configured to hold the hard tissue in a fixed position using a clamp mechanism.

13. The hard tissue slicing machine of claim 10, wherein the slicing speed is maintained between 0.1 mm/s and 5 mm/s.

14. The hard tissue slicing machine of claim 10, wherein the inclination angle of the slicing blade relative to the hard tissue is set between 15 degrees and 25 degrees.

15. The hard tissue slicing machine of claim 10, wherein the hard tissue includes hard tissues and ordinary soft tissues embedded in the resin block as a medium having a hardness of at least 70 Shore D.

16. The hard tissue slicing machine of claim 10, wherein the thickness of slices is set ranging from 2 μm to 5 μm.

17. The hard tissue slicing machine of claim 10, wherein the resin block embedding the hard tissue is pre-cooled to a temperature of −20° C. to 4° C.

18. The hard tissue slicing machine of claim 10, wherein the sliced tissue is inspected using optical microscopy to confirm the absence of wrinkles or detachment.
